(19) United States
(12) Patent Application Publication
(10) Pub. No.: US 2024/0152734 A1
(43) Pub. Date: May 9, 2024

(54) TRANSFORMER ARCHITECTURE THAT DYNAMICALLY HALTS TOKENS AT INFERENCE

(71) Applicant: GM Cruise Holdings LLC, San Francisco, CA (US)

(72) Inventor: Mao Ye, San Francisco, CA (US)

(21) Appl. No.: 18/500,485

(22) Filed: Nov. 2, 2023

Related U.S. Application Data
(60) Provisional application No. 63/421,939, filed on Nov. 2, 2022.

(51) Int. Cl. G06N 3/0455; B60W 60/00; G06N 3/084

(52) U.S. Cl. CPC G06N 3/0455; B60W 60/001; G06N 3/084; B60W 2420/42; B60W 2420/52; B60W 2556/35

(57) ABSTRACT

Systems and techniques are provided for performing object detection using a machine learning model with a transformer architecture. An example method can include receiving a plurality of tokens corresponding to segmented sensor data; identifying, by a halting module within the machine learning model, at least one halted token from the plurality of tokens, wherein the at least one halted token is excluded from a plurality of non-halted tokens provided as input to a subsequent layer during inference of the machine learning model; and detecting, by the machine learning model, at least one detected object based at least on the plurality of non-halted tokens.

### CROSS-REFERENCE TO RELATED APPLICATIONS

The present application claims the benefit of U.S. Provisional Application No. 63/421,939, filed on Nov. 2, 2022, which is hereby incorporated by reference in its entirety.

### BACKGROUND

### 1. Technical Field

The present disclosure generally relates to autonomous vehicles and, more specifically, to transformer-based machine learning models that may be used by autonomous vehicles and that can be configured to dynamically halt tokens at inference.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a diagram illustrating an example system environment that can be used to facilitate autonomous vehicle (AV) navigation and routing operations, in accordance with some examples of the present disclosure;

FIG. 2 is a diagram illustrating an example system for implementing a transformer-based machine learning models that can be configured to perform object detection and dynamically halt tokens at inference, in accordance with some examples of the present disclosure;

FIG. 3 is a diagram illustrating an example of a halting module that may be used in a transformer-based machine learning model, in accordance with some examples of the present disclosure;

FIG. 4 is a flowchart illustrating another example process for using a transformer-based machine learning model to perform object detection and dynamically halt tokens at inference, in accordance with some examples of the present disclosure; and

FIG. 5 is a diagram illustrating an example system architecture for implementing certain aspects described herein.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Autonomous vehicles (AVs), also known as self-driving cars, driverless vehicles, and robotic vehicles, are vehicles that use sensors to sense the environment and move without human input. For example, AVs can include sensors such as a camera sensor, a LIDAR sensor, and/or a RADAR sensor, amongst others, which the AVs can use to collect data and measurements that are used for various AV operations. The sensors can provide the data and measurements to an internal computing system of the autonomous vehicle, which can use the data and measurements to control mechanical systems of the autonomous vehicle, such as a vehicle propulsion system, a braking system, and/or a steering system, etc.

In some aspects, autonomous vehicles may use one or more machine learning models to process sensor data and perform functions such as object detection, object classification, object path prediction, etc. Implementation of such models provides challenges in balancing model efficiency and accuracy. The trade-off between efficiency and accuracy becomes more important when the models are used for real-time safety-critical systems within an autonomous vehicle.

Transformer based architectures can be implemented that meet or exceed the performance of convolutional neural networks. However, transformer architectures may exhibit higher latency, which hinders performance for real-time safety-critical or edge-computing applications.

Systems and techniques are provided herein for implementing transformer-based machine learning models that may be used by autonomous vehicles and that can be configured to dynamically halt tokens at inference in order to reduce latency at inference. In some aspects, a transformer-based machine learning model can include a halting module that can prune or halt tokens. That is, the halting module can reduce superfluous tokens in order to reduce the computational complexity of the transformer's attention mechanism.

In some aspects, the present technology provides a deterministic module that can progressively halt tokens throughout the transformer. In some cases, the present technology can include a token recycling mechanism that allows reuse of the information from the halted tokens (e.g., by the detection head). In some examples, an equivalent differentiable forward pass can be used to overcome the non-differentiability of token halting. In some configurations, a non-uniform token sparsity loss can be employed to improve the learning of the halting module by utilizing ground-truth bounding boxes.

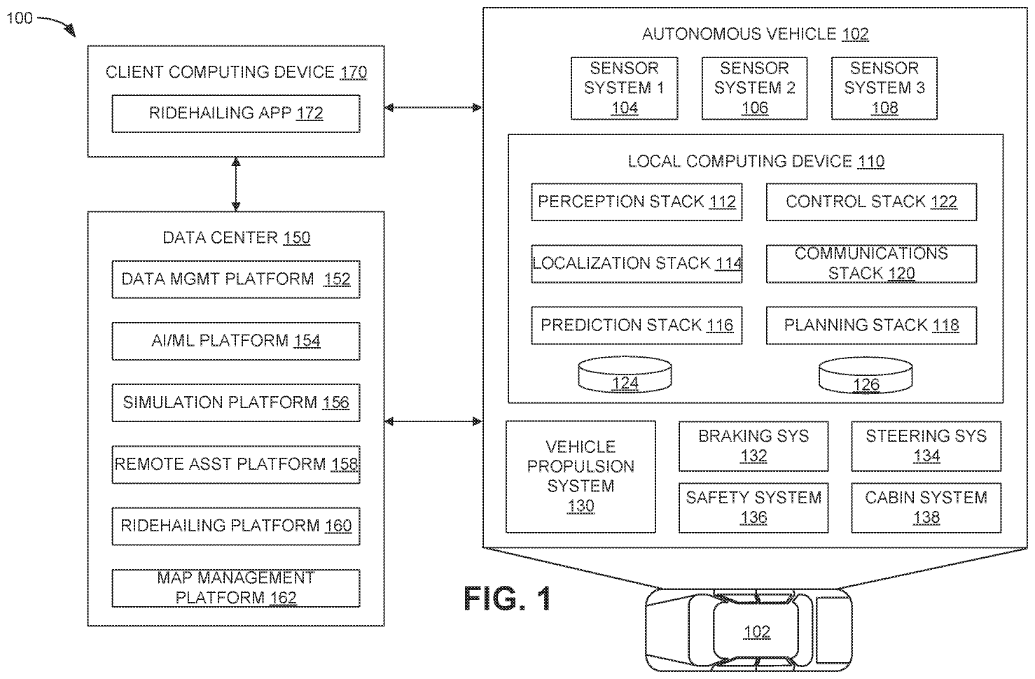

FIG. 1 is a diagram illustrating an example autonomous vehicle (AV) environment 100, according to some examples of the present disclosure. One of ordinary skill in the art will understand that, for the AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the perception stack 112 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridehailing service (e.g., a ridesharing service), a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridehailing/ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridehailing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridehailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridehailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridehailing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridehailing platform 160 can interact with a customer of a ridehailing service via a ridehailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridehailing application 172. The client computing device 170 can be a customer's mobile computing device or a computing device integrated with the AV 102 (e.g., the local computing device 110). The ridehailing platform 160 can receive requests to pick up or drop off from the ridehailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridehailing platform 160 may incorporate the map viewing services into the ridehaling application 172 to enable passengers to view the AV 102 in transit en route to a pick-up or drop-off location, and so on.

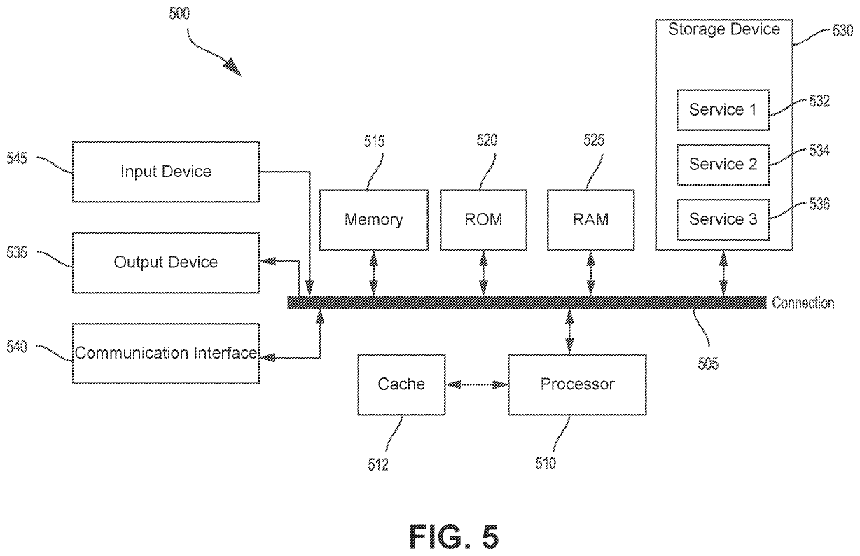

While the autonomous vehicle 102, the local computing device 110, and the autonomous vehicle environment 100 are shown to include certain systems and components, one of ordinary skill will appreciate that the autonomous vehicle 102, the local computing device 110, and/or the autonomous vehicle environment 100 can include more or fewer systems and/or components than those shown in FIG. 1. For example, the autonomous vehicle 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 5.

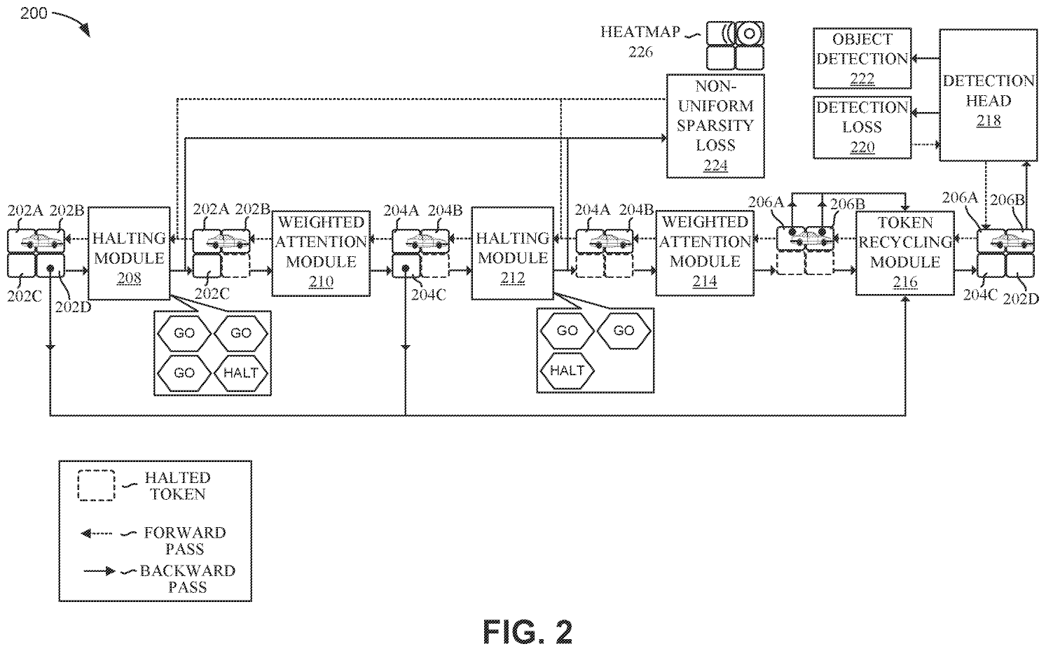

FIG. 2 is a diagram illustrating an example system 200 for implementing a transformer-based machine learning model that can be configured to perform object detection and dynamically halt tokens at inference, in accordance with some examples of the present disclosure. In some aspects, system 200 can be based on a Single-stride Sparse Transformer (SST), that can be a LiDAR-based 3D object detector. However, the present technology is not limited to a particular sensor modality and may be used to perform object detection based on other types of sensors such as camera sensors, RADAR sensors, Time-of-Flight (ToF), any other type of sensor, and/or any combination thereof.

In some examples, dynamic voxelization can be used to create a set of voxel features, f₀ (e.g., in a bird's eye view). In some aspects, the voxels may be treated as tokens within the transformer (the term “voxel” and “token” may be used interchangeably herein). For instance, dynamic voxelization can be used to create token 202A, token 202B, token 202C, and token 202D (collectively referred to as “tokens 202”). In some examples, SST can use regional grouping to divide the token grid into non-overlapping regions and may apply sparse regional attention (SRA) to tokens within each region. For example:

SRA(fₗ)=MLP(LN(f′ₗ))+f′ₗ (1)
in which,

f′ₗ=MSA(LN(fₗ), PE(fₗ))+fₗ (2)

In Equation (1) and Equation (2) above, the terms LN, MLP, PE, and MSA correspond to layer normalization, token-wise multi-layer perceptron, position encoding, and multi-head self-attention, respectively. In some aspects, objects can lay within several regions and multiple SRA operations can be performed sequentially in which the regional grouping can be shifted for one of the operations. That is, the (l+1)-th features can be generated according to Equation (3) below, in which SSRA corresponds to the shifted sparse region attention.

fₗ₊₁=SSRA(SRA(fₗ)) (3)

In some aspects, the machine learning model can include multiple layers that are configured to process tokens 202. In some configurations, each layer of the transformer backbone may process the tokens 202 according to Equation (4), in which ϕ₁ and ϕ₂ correspond to non-linear token-wise operations and SA corresponds to a general self-attention mechanism, as follows:

fₗ₊₁=ϕ₂(SA(ϕ₁(fₗ)), fₗ) (4)

In some examples, some of tokens 202 may include data/features that have greater relevance or importance for a detection task. In some instances, a token may be useful at an early stage of the network but less informative at the later stages. For example, detecting a vehicle on an empty road may require several late stage tokens from the vehicle itself (e.g., token 202A and token 202B), but only a few early stage tokens from the surrounding environment (e.g., token 202C and token 202D). In another example, detecting a camouflaged pedestrian may require several late stage tokens corresponding to both the person and the surrounding environment.

In some aspects, system 200 can be trained to learn a token halting mechanism that can identify which tokens should be halted and which tokens should be forwarded to the subsequent layer. For example, given N token features, fₗ={f_{l,i}: i∈{1, . . . , N}}, from the l-th layer, the halting module (e.g., halting module 208 or halting module 212) can output a binary mask, kₗ∈{0,1}^{N}, indicating which of the tokens (e.g., tokens 202) are forwarded to the next layer. In particular, in some configurations, the subsequent layer's tokens can be computed according to Equation (5) below, in which \hat{f}ₗ={f_{l,i}: k_{l,i}=1} are the tokens kept by the halting module.

fₗ₊₁=ϕ₂(SA(ϕ₁(\hat{f}ₗ)), \hat{f}ₗ) (5)

In some examples, halting module 208 and/or halting module 212 can output a binary mask kₗ that can determine whether a token is forwarded to the next layer. To create such a mask, halting module 208 and/or halting module 212 can compute a non-negative score s for each of the tokens 202. Halting module 208 and/or halting module 212 may use any suitable architecture to produce the score. For instance, the score can be produced by an MLP or by a transformer. In some instances, halting module 208 and/or halting module 212 can obtain the mask by thresholding the score, kₗ=ψ(sₗ), where φ(sₗ≥u} and u is a threshold. In some configurations, the threshold can be a fixed value. In some cases, the threshold can be selected dynamically (e.g., using the distribution of scores).

Each layer within the machine learning model can have its own halting module. Although system 200 is illustrated as having only 2 layers (e.g., with halting module 208 and halting module 212), those skilled in the art will recognize the present technology is not limited to any particular number of layers and alternative configurations are contemplated herein. In some configurations, different halting layers within the machine learning model may utilize different architectures. For example, in some cases a halting layer in an earlier layer may utilize a more complicated architecture whereas later layers in the network may be configured to utilize more simple architectures.

In some cases, system 200 can include two dynamic halting modules before the first and second SRA blocks (not illustrated). In some examples, such a configuration may yield a high level of token sparsity without adversely affecting performance. In some cases, additional modules to further increase sparsity may be included. However, in some examples, adding additional modules may not be needed (e.g., additional modules may provide limited increase in speed). As noted above, a complex architecture may be used for some halting modules (e.g., the first halting module) and a simpler architecture may be used for other halting modules. In one illustrative example, the complex architecture may correspond to a lightweight U-Net architecture with MobileNetV2 blocks may be used, and a linear layer with sigmoid activation to obtain the halting score. In another example, the simpler architecture may correspond to a one-layer MLP on the input feature to produce the score.

In some instances, a halting module (e.g., halting module 208 and/or halting module 212) may use the first 32 features of a token as an input. In some examples, latent features extracted by halting modules may be reused by fusing the penultimate latent features back into the token features.

In some configurations, the halting threshold u can be adjusted to obtain different levels of token sparsity. For instance, the threshold may be configured such that only a certain quantile of tokens 202 are halted. In some cases, a threshold that is based on score quantiles can be used to stabilize training. In one illustrative example, an upper and lower token score quantile (denoted as αᵤ and αₗ) can be specified and the sparsity of each layer can be enforced to vary within [αₗ, αᵤ]. In some cases, the final threshold can be given by clamping the pre-specified threshold within [Q(αₗ), Q(αᵤ)], where Q(αₗ) and Q(αᵤ) denote the score corresponding to the αₗ and αᵤ, respectively. In some cases in which a new dataset/model is used, the model may be trained for a short period and the threshold can be selected such that it is higher than the score of the most foreground voxels and less than the score of most background voxels.

In some aspects, system 200 can include one or more weighted attention modules (e.g., weighted attention module 210 and weighted attention module 214). In some cases, the weighted attention module(s) may perform a weighted self-attention operation WSA(fₗ, sₗ) that weights the tokens based on the score sₗ produced by the halting module. In some examples, the output of the weight self-attention for the i-th token can be defined as follows:

$${WSA ( {f}_{l} , {s}_{l} )}_{i} = \frac{{\sum }_{j} exp ( {P}_{ij} ) {s}_{l , j} {v}_{j}}{{\sum }_{k} exp ( {P}_{ik} ) {s}_{l , k}} \qquad ( 6 )$$

In which,

P=(W_{Q}fₗ)(W_{K}fₗ)/\sqrt{d}, v=W_{V}fₗ (7)

In Equation (7), W_{Q}, W_{K}, and W_{V} correspond to the queue, key, and value matrices, respectively. It is noted that the foregoing definition assumes a standard self-attention operation but may be applied to other variants.

In some aspects, using the token score sₗ as the weight can cause the attention given to a particular token to be proportional to that token's score. Such a configuration can encourage the halting module to increase the score of a token if it plays an important role within the mechanism. For instance, halting module 208 can generate a relatively high score for token 202A and for token 202B, which include features corresponding to the car. Also, halting module 208 can generate a relatively low score for token 202C and for token 202D, which do not include any features corresponding to the car.

As illustrated, the score for token 202D is below the threshold and token 202D is halted by halting module 208. Furthermore, weighted attention module 210 can weigh the unhalted tokens based on the score determined by halting module 208. That is, weighted attention module 210 can apply a score to token 202A to generate weighted token 204A; weighted attention module 210 can apply a score to token 202B to generate weighted token 204B; and weighted attention module 210 can apply a score to token 202C to generate weighted token 204C. Similarly, the score for token 204C is below the threshold and token 204C is halted by halting module 212. Further, weighted attention module 214 can weigh the unhalted tokens based on the score determined by halting module 212. That is, weighted attention module 214 can apply a score to token 204A to generate weighted token 206A; and weighted attention module 214 can apply a score to token 204B to generate weighted token 206B.

In some aspects, halted tokens (e.g., token 202D halted by halting module 208 and token 204C halted by halting module 212) may include features that are useful to inform the final predictions of the model. In some configurations, system 200 may include a token recycling module 216 that can be configured to recycle halted tokens and forward them to the detection head 218. In some aspects, the token recycling module 216 can construct a bird's eye view feature map \hat{f}_{BEV} that is assembled from both the output of the transformer (e.g., token 206A and token 206B) and the halted tokens (e.g., token 202D and token 204C).

In some aspects, the token halting operation performed by the halting modules is non-differentiable (e.g., token halting can be an issue for training with gradient descent). In some configurations, an equivalent differentiable forward-pass (EDF) can be used during training that can be used to produce a forward-pass that generates an equivalent output but is differentiable. That is, in some cases, training performed with EDF can forward all tokens to the subsequent layer, which is different from inference in which halted tokens are not forwarded to subsequent layer. However, during training the halted tokens that are forwarded to the subsequent layer can be prevented from interacting with other tokens by using the mask as a multiplier on their score, as follows:

fₗ₊₁=ϕ₂(WSA(ϕ₁(fₗ), sₗ∘k_{0,l}), fₗ) (8)
in which

k_{0,l}=k₀∘ . . . ∘kₗ (9)

In Equation (9), ∘ can denote an element-wise multiplication. It is noted that in some aspects k₀:=1. For each token, f_{BEV} can be constructed based on token feature(s) at the layer in which it was halted. In some examples, EDF can define the feature map as per Equation (10) below so that the value of the output remains the same as that at inference time while making the output differentiable.

$${f}_{BEV} = {\sum }_{l = 1}^{L + 1} ( {k}_{0 : l - 1} - {k}_{0 : l )} ∘ {f}_{l} \qquad ( 10 )$$

In some examples, k_{0:L+1}:=0, where L is the total number of layers. Although inference and training have different forward passes due to EDF, it yet follows that f_{BEV}=\hat{f}_{BEV}.

In some aspects, the binary mask kₗ can be produced by thresholding the token's score sₗ, and the thresholding function ψ(sₗ) can have zero gradients almost everywhere. To enable back-propagation, a straight-through estimator (STE) can be used that defines a pseudo-gradient during the back-propagation by replacing the derivative of the threshold function with the derivative of a different activation function, as follows:

ψ′(sₗ):=σ′(sₗ) (11)

In some examples, an identify function can be used for σ. Alternatively, any other activation function such as a rectified linear unit (ReLU) activation function may also be used.

It is noted that using the present technology EDF and STE can be combined to yield a computation graph at training that is fully differentiable.

In some aspects, the halting modules (e.g., halting module 208 and/or halting module 212) can be trained or configured to output a sparse binary mask. In some cases, a sparse binary mask can be generated by penalizing the scores with a [symbol] ₁ penalty (e.g., least absolute shrinkage and selection operator (LASSO)). In some instances, the penalty can be applied uniformly to all tokens.

In further examples, a non-uniform penalty (e.g., non-uniform sparsity loss 224) can be applied to the tokens. That is, tokens belonging to a foreground object can be considered to be of greater importance than tokens belonging to a background object. Thus, a non-uniform penalty can be used to yield foreground tokens with a larger score than background tokens (e.g., on average). In some aspects, such a non-uniform penalty can be achieved by leveraging the ground-truth bounding boxes and creating a heatmap (e.g., heatmap 226). In some configurations, tokens that are within a bounding box can have a positive value in the heatmap (e.g., between 0 and 1). In some examples, a token's value can increase as it gets closer to the center of the object. In some aspects, tokens that do not fall inside any bounding box can have a value of zero in the heatmap 226. In some cases, differences between sₗ and the heatmap can be penalized using a focal loss that applies a uniform sparse penalty to the background tokens and a non-uniform penalty to the foreground tokens (e.g., based on distance to object center).

In some aspects, the feature map f_{BEV} can be forwarded to the center-point detection head (e.g., detection head 218) for predictions. In some examples, the model can be trained end-to-end with a total loss defined as:

[symbol]

=λ_{b} [symbol] _{b}+λₕ [symbol] ₕ+λₛ [symbol] ₛ (12)
where [symbol] _{b} and [symbol] ₕ correspond to the box and heatmap regression losses (e.g., detection loss 220) and [symbol] ₛ is the non-uniform sparsity loss 224.

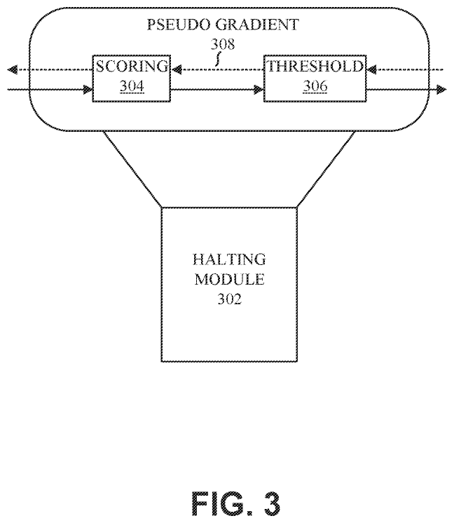

FIG. 3 is a diagram illustrating an example of a halting module 302 that may be used in a transformer-based machine learning model. In some aspects, halting module 302 may correspond to halting module 208 or to halting module 212. As noted above, halting module 302 may be implemented using a complex architecture or a more simplified architecture, depending on the layer in which the halting module 302 is operating within the machine learning model.

In some aspects, halting module 302 may perform scoring 304 of one or more tokens (e.g., tokens 202). In some cases, scoring may be based on features associated with the token. For instance, as noted above, tokens corresponding to foreground objects may have higher scores than tokens corresponding to background objects.

In some cases, halting module 302 may halt (e.g., prevent) tokens having a score that is below a threshold 306 value from being sent to a subsequent attention layer within the machine learning model. In some aspects, the threshold 306 can be an absolute value while in other examples, the threshold 306 can be based on a distribution of the scores (e.g., scoring 304) for all of the tokens.

In some aspects, halting module 302 may be configured to forward tokens that are designated as halted tokens during training (e.g., tokens having a score that is below the threshold 306). The halted tokens that are forwarded during training are prevented from interacting with the other (e.g., non-halted) tokens. In some examples, forwarding of halted tokens during training can be done to obtain a pseudo gradient 308 to back-propagate through the non-differentiable threshold operation. That is, the network can be trained end-to-end using both a detection loss and a non-uniform sparsity loss.

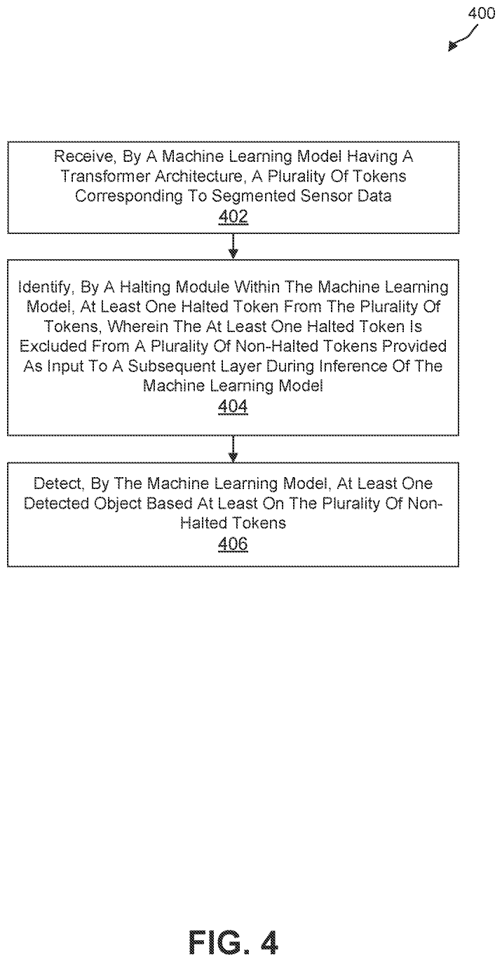

FIG. 4 illustrates an example of a process 400 for using a transformer-based machine learning model to perform object detection and dynamically halt tokens at inference. Although the process 400 depicts a particular sequence of operations, the sequence may be altered without departing from the scope of the present disclosure. For example, some of the operations depicted may be performed in parallel or in a different sequence that does not materially affect the function of process 400. In other examples, different components of an example device or system that implements process 400 may perform functions at substantially the same time or in a specific sequence.

At step 402, the process 400 includes receiving, by a machine learning model having a transformer architecture, a plurality of tokens corresponding to segmented sensor data. For example, the machine learning model of system 200 can receive tokens 202 which correspond to segmented sensor data. In some aspects, the segmented sensor data can be based on at least one of light detection and ranging (LiDAR) sensor data, camera sensor data, radar sensor data, and a fusion of sensor data.

At step 404, the process 400 includes identifying, by a halting module within the machine learning model, at least one halted token from the plurality of tokens, wherein the at least one halted token is excluded from a plurality of non-halted tokens provided as input to a subsequent layer during inference of the machine learning model. For example, halting module 208 can identify token 202D as a halted token that is excluded from the non-halted tokens (e.g., token 202A, token 202B, and token 202C) that are provided to a subsequent layer.

At step 406, the process 400 includes detecting, by the machine learning model, at least one detected object based at least on the plurality of non-halted tokens. For example, detection head 218 can use token 206A and token 206B to make object detection 222.

In some cases, identifying the at least one halted token can include determining a token score for each of the plurality of tokens; and determining that the token score corresponding to the at least one halted token is less than a threshold token score. For example, halting module 208 may determine a token score for tokens 202 and halting module 208 can determine that the token score for token 202D is less than a threshold token score. In some aspects, the threshold token score is based on a distribution of token scores for the plurality of tokens. In some cases, the token score for each of the plurality of tokens can be based on a position of a respective token relative to a foreground object, wherein the token score increases when the position of the respective token is closer to a center of the foreground object.

In some configurations, the process 400 can include applying, by a weighted attention module within the machine learning model, a weight to each of the plurality of non-halted tokens, wherein the weight is based on the token score. For instance, weighted attention module 210 can apply a weight to token 202A to yield token 204A.

In some aspects, the process 400 can include combining, by a token recycling module disposed between a final attention layer of the machine learning model and a detection head of the machine learning model, the at least one halted token with the plurality of non-halted tokens to yield a recombined set of tokens, wherein the at least one detected object is based on the recombined set of tokens. For instance, token recycling module 216 can combine at least one halted token (e.g., token 202D and/or token 204C) with the non-halted tokens (e.g., token 206A and token 206B), and detection head 218 can make object detection 222 based on the combination of the halted tokens and the non-halted tokens assembled by the token recycling module 216.

In some examples, the process 400 can include forwarding, during training of the machine learning model, the at least one halted token to the subsequent layer; and applying a mask to the at least one halted token, wherein the mask prevents the at least one halted token from interacting with the plurality of non-halted tokens. For instance, halting module 208 may forward token 202D (e.g., halted token) to a subsequent layer during training and halting module 208 and/or weighted attention module 210 may apply a mask to token 202D that prevents token 202D from interacting with non-halted tokens (e.g., token 202A, token 202B, and token 202C).

FIG. 5 illustrates an example processor-based system with which some aspects of the subject technology can be implemented. For example, processor-based system 500 can be any computing device making up internal computing system 110, a passenger device executing the ridehailing application 172, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some examples, computing system 500 is a distributed system in which the functions described in this disclosure can be distributed within a datacenter, multiple data centers, a peer network, etc. In some cases, one or more of the described system components represents many such components each performing some or all of the function for which the component is described. In some aspects, the components can be physical or virtual devices.

Example system 500 includes at least one processing unit (CPU or processor) 510 and connection 505 that couples various system components including system memory 515, such as read-only memory (ROM) 520 and random-access memory (RAM) 525 to processor 510. Computing system 500 can include a cache of high-speed memory 512 connected directly with, in close proximity to, and/or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 can include an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ultra-wideband (UWB) wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L#), resistive random-access memory (RRAM/ReRAM), phase change memory (PCM), spin transfer torque RAM (STT-RAM), another memory chip or cartridge, and/or a combination thereof.

Storage device 530 can include software services, servers, services, etc., that when the code that defines such software is executed by the processor 510, causes the system to perform a function. In some examples, a hardware service that performs a particular function can include the software component stored in a computer-readable medium in connection with the necessary hardware components, such as processor 510, connection 505, output device 535, etc., to carry out the function.

As understood by those of skill in the art, machine-learning techniques can vary depending on the desired implementation. For example, machine-learning schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

### SELECTED EXAMPLES

Illustrative examples of the disclosure include:

Aspect 1. A computer-implemented method comprising: receiving, by a machine learning model having a transformer architecture, a plurality of tokens corresponding to segmented sensor data; identifying, by a halting module within the machine learning model, at least one halted token from the plurality of tokens, wherein the at least one halted token is excluded from a plurality of non-halted tokens provided as input to a subsequent layer during inference of the machine learning model; and detecting, by the machine learning model, at least one detected object based at least on the plurality of non-halted tokens.

Aspect 2. The computer-implemented method of Aspect 1, further comprising: combining, by a token recycling module disposed between a final attention layer of the machine learning model and a detection head of the machine learning model, the at least one halted token with the plurality of non-halted tokens to yield a recombined set of tokens, wherein the at least one detected object is based on the recombined set of tokens.

Aspect 3. The computer-implemented method of any of Aspects 1 to 2, wherein identifying the at least one halted token further comprises: determining a token score for each of the plurality of tokens; and determining that the token score corresponding to the at least one halted token is less than a threshold token score.

Aspect 4. The computer-implemented method of Aspect 3, further comprising: applying, by a weighted attention module within the machine learning model, a weight to each of the plurality of non-halted tokens, wherein the weight is based on the token score.

Aspect 5. The computer-implemented method of any of Aspects 3 to 4, wherein the threshold token score is based on a distribution of token scores for the plurality of tokens.

Aspect 6. The computer-implemented method of any of Aspects 3 to 5, wherein the token score for each of the plurality of tokens is based on a position of a respective token relative to a foreground object, wherein the token score increases when the position of the respective token is closer to a center of the foreground object.

Aspect 7. The computer-implemented method of any of Aspects 1 to 6, further comprising: forwarding, during training of the machine learning model, the at least one halted token to the subsequent layer; and applying a mask to the at least one halted token, wherein the mask prevents the at least one halted token from interacting with the plurality of non-halted tokens.

Aspect 8. The computer-implemented method of any of Aspects 1 to 7, wherein the segmented sensor data is based on at least one of light detection and ranging (LiDAR) sensor data, camera sensor data, radar sensor data, and a fusion of sensor data.

Aspect 9. An apparatus comprising: at least one memory; and at least one processor coupled to the at least one memory, wherein the at least one processor is configured to perform operations in accordance with any one of Aspects 1 to 8.

Aspect 10. An apparatus comprising means for performing operations in accordance with any one of Aspects 1 to 8.

Aspect 11. A non-transitory computer-readable medium comprising instructions that, when executed by an apparatus, cause the apparatus to perform operations in accordance with any one of Aspects 1 to 8.

The various examples described above are provided by way of illustration only and should not be construed to limit the scope of the disclosure. For example, the principles herein apply equally to optimization as well as general improvements. Various modifications and changes may be made to the principles described herein without following the examples and applications illustrated and described herein, and without departing from the scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A system comprising:
at least one memory comprising instructions; and
at least one processor coupled to the at least one memory, wherein the at least one processor is configured to:
receive, by a machine learning model having a transformer architecture, a plurality of tokens corresponding to segmented sensor data;
identify, by a halting module within the machine learning model, at least one halted token from the plurality of tokens, wherein the at least one halted token is excluded from a plurality of non-halted tokens provided as input to a subsequent layer during inference of the machine learning model; and
detect, by the machine learning model, at least one detected object based at least on the plurality of non-halted tokens.

2. The system of claim 1, wherein the at least one processor is further configured to:
combine, by a token recycling module disposed between a final attention layer of the machine learning model and a detection head of the machine learning model, the at least one halted token with the plurality of non-halted tokens to yield a recombined set of tokens, wherein the at least one detected object is based on the recombined set of tokens.

3. The system of claim 1, wherein to identify the at least one halted token the at least one processor is further configured to:
determine a token score for each of the plurality of tokens; and
determine that the token score corresponding to the at least one halted token is less than a threshold token score.

4. The system of claim 3, wherein the at least one processor is further configured to:
apply, by a weighted attention module within the machine learning model, a weight to each of the plurality of non-halted tokens, wherein the weight is based on the token score.

5. The system of claim 3, wherein the threshold token score is based on a distribution of token scores for the plurality of tokens.

6. The system of claim 3, wherein the token score for each of the plurality of tokens is based on a position of a respective token relative to a foreground object, wherein the token score increases when the position of the respective token is closer to a center of the foreground object.

7. The system of claim 1, wherein the at least one processor is further configured to:
forward, during training of the machine learning model, the at least one halted token to the subsequent layer; and
apply a mask to the at least one halted token, wherein the mask prevents the at least one halted token from interacting with the plurality of non-halted tokens.

8. The system of claim 1, wherein the segmented sensor data is based on at least one of light detection and ranging (LiDAR) sensor data, camera sensor data, radar sensor data, and a fusion of sensor data.

9. A computer-implemented method comprising:
receiving, by a machine learning model having a transformer architecture, a plurality of tokens corresponding to segmented sensor data;
identifying, by a halting module within the machine learning model, at least one halted token from the plurality of tokens, wherein the at least one halted token is excluded from a plurality of non-halted tokens provided as input to a subsequent layer during inference of the machine learning model; and
detecting, by the machine learning model, at least one detected object based at least on the plurality of non-halted tokens.

10. The computer-implemented method of claim 9, further comprising:
combining, by a token recycling module disposed between a final attention layer of the machine learning model and a detection head of the machine learning model, the at least one halted token with the plurality of non-halted tokens to yield a recombined set of tokens, wherein the at least one detected object is based on the recombined set of tokens.

11. The computer-implemented method of claim 9, wherein identifying the at least one halted token further comprises:
determining a token score for each of the plurality of tokens; and
determining that the token score corresponding to the at least one halted token is less than a threshold token score.

12. The computer-implemented method of claim 11, further comprising:
applying, by a weighted attention module within the machine learning model, a weight to each of the plurality of non-halted tokens, wherein the weight is based on the token score.

13. The computer-implemented method of claim 11, wherein the threshold token score is based on a distribution of token scores for the plurality of tokens.

14. The computer-implemented method of claim 11, wherein the token score for each of the plurality of tokens is based on a position of a respective token relative to a foreground object, wherein the token score increases when the position of the respective token is closer to a center of the foreground object.

15. The computer-implemented method of claim 9, further comprising:
forwarding, during training of the machine learning model, the at least one halted token to the subsequent layer; and
applying a mask to the at least one halted token, wherein the mask prevents the at least one halted token from interacting with the plurality of non-halted tokens.

16. The computer-implemented method of claim 9, wherein the segmented sensor data is based on at least one of light detection and ranging (LiDAR) sensor data, camera sensor data, radar sensor data, and a fusion of sensor data.

17. An autonomous vehicle comprising:
at least one memory comprising instructions;
at least one autonomous vehicle sensor; and
at least one processor coupled to the at least one autonomous vehicle sensor and the at least one memory, wherein the at least one processor is configured to:
obtain sensor data from the at least one autonomous vehicle sensor;
segment the sensor data to yield a plurality of tokens;
identify, using a machine learning model having a transformer architecture, at least one halted token from the plurality of tokens, wherein the at least one halted token is excluded from a plurality of non-halted tokens provided as input to a subsequent layer during inference of the machine learning model; and
detect, using the machine learning model, at least one detected object based at least on the plurality of non-halted tokens.

18. The autonomous vehicle of claim 17, wherein the at least one processor is further configured to:
combine, by a token recycling module disposed between a final attention layer of the machine learning model and a detection head of the machine learning model, the at least one halted token with the plurality of non-halted tokens to yield a recombined set of tokens, wherein the at least one detected object is based on the recombined set of tokens.

19. The autonomous vehicle of claim 17, wherein to identify the at least one halted token the at least one processor is further configured to:
determine a token score for each of the plurality of tokens; and
determine that the token score corresponding to the at least one halted token is less than a threshold token score.

20. The autonomous vehicle of claim 19, wherein the at least one processor is further configured to:
apply, by a weighted attention module within the machine learning model, a weight to each of the plurality of non-halted tokens, wherein the weight is based on the token score.
